(19) United States
(12) Patent Application Publication
(10) Pub. No.: US 2006/0284532 A1
(43) Pub. Date: Dec. 21, 2006

(54) Color display unit

(76) Inventors: Makoto Kurihara, Chiba-shi (JP); Norihiro Dejima, Chiba-shi (JP); Katsuyuki Igarashi, Chiba-shi (JP); Mitsuyoshi Hara, Chiba-shi (JP)

Correspondence Address: BRUCE L. ADAMS, ESQ.;SUITE 1231, 17 BATTERY PLACE, NEW YORK, NY, 10004, US

(21) Appl. No.: 11/439,902

(22) Filed: May 24, 2006

(30) Foreign Application Priority Data
Jun. 15, 2005 (JP) 2005-174942
Dec. 6, 2005 (JP) 2005-351721

(51) Int. Cl. H01K 1/30; H01J 5/16

(52) U.S. Cl. 313/110; 313/112

(57) ABSTRACT

There is provided a color display unit having a wide range of color reproduction and low power consumption, with a simple structure, and without causing element deterioration. The display unit comprises light source means for generating blue light, a color conversion layer having a red color region for converting the blue light generated by the light source means to red light, a green color region for converting the blue light to green light, and a blue color region for transmitting the blue light as is, arranged on a flat surface, and a pixel switch structure for turning the blue light ON or OFF for each of the red color region, green color region and blue color region in response to an image signal.

### BACKGROUND OF THE INVENTION

The present invention relates to a color image display unit used in mobile information units, such as mobile phones or mobile computers, or in large scale image apparatus such as desktop computers or household televisions

Conventionally, small thin type low power consumption color liquid crystal display units have often been used as a color image display unit used in mobile information units such as mobile telephones or mobile computers. High brilliance low power consumption color liquid crystal display units are also spreading rapidly in the field of large-scale image display apparatus such as desktop computers and household televisions. These liquid crystal display units achieve smaller and thinner structures, and reduced power consumption with prolonged lifespan, compared to the case of conventional cold cathode tubes, due to the fact that a white LED is used as an illuminated light source. On the other hand, with a semi-transmissive liquid crystal display unit used in a mobile telephone, an objective is to further promote reduced power consumption, and a structure where a red fluorescent material, a green fluorescent material and a blue fluorescent material for respectively generating red light, green light and blue light are mixed by ultraviolet light inside a color filter is disclosed, for example, in Japanese patent laid-open No. 2004-287324 (patent publication 1).

However, with the conventional structure where fluorescent material is mixed inside a color filter, excitation light is ultraviolet, which means that as well as the fact that ultra violet light absorption inside the liquid crystal elements is large giving bad efficiency, ultra violet light influences the liquid crystal molecules or liquid crystal orientation, and there is a danger of promoting element deterioration. A complex element structure has been required in order to prevent these problems.

### SUMMARY OF THE INVENTION

It is an object of the present invention to provide a color display unit having a wide range of color reproduction and low power consumption, with a simple structure, and without causing element deterioration.

A color display unit of the present invention for solving the above described problems comprises a blue light source for generating blue light, a color conversion layer having a red color region for converting the blue light generated by the blue light source to red light, a green color region for converting the blue light to green light, and a blue color region for transmitting the blue light, arranged on a flat surface, and a pixel switch structure for ON/OFF control of transmission of the blue light for each of the red color region, green color region and blue color region in response to an image signal. With this type of structure, a color image is displayed using converted red light and green light, and blue light, which means that it is possible to display an image over a wider color reproduction range with high efficiency. Here, by having a structure where the red color region is a red fluorescent material layer and the green color region is a green fluorescent material layer, it becomes possible to use blue light as excitation light for the fluorescent material of each fluorescent material layer, and it is possible to avoid deterioration of the display elements.

Also, a red filter for passing red light and a green filter for passing green light are provided for respective transmitted light of the red color region and the green color region. With this type of structure, it is possible to improve color purity of red light and green light used in color display, and it becomes possible to display a color image having a wider color reproduction range. Further, it is possible to provide a blue color filter for selectively transmitting a blue wavelength range, so as to correspond to the blue color region.

Alternatively, a filter is provided to absorb the blue light wavelength region, so as top correspond to the red color region and the green color region. In this way, it becomes possible to perform display with good color purity even if a color filter is not used.

Further, a polarizing element for transmitting light in a particular polarization direction is provided beyond the filter layer, so that a polarization direction of transmitted blue polarized light intersects the red color region and the green color region. Alternatively, a circularly polarizing element is provided beyond the filter layer.

Here, it is possible to use a liquid crystal display element as a pixel switch structure. Alternatively, instead of the blue light source and the pixel switch structure, it is possible to use a self emissive display element for emitting blue light, for example, an EL display element, or an organic EL display element.

Also with the present invention, a blue light source for emitting blue light is made a blue LED. With these measures, it is possible to realize high brilliance color image display with high reliability.

### BRIEF DESCRIPTION OF THE DRAWINGS

FIG. 1 is a schematic drawing for describing the concept of the present invention;

FIG. 2 is a cross sectional drawing schematically showing the structure of a color display unit of the present invention;

FIG. 3 is a cross sectional drawing schematically showing the structure of a color display unit of the present invention;

FIG. 4 is a cross sectional drawing schematically showing the structure of a color display unit of the present invention;

FIG. 5 is a cross sectional drawing schematically showing the structure of a color display unit of the present invention;

FIG. 6 is a cross sectional drawing schematically showing the structure of a color display unit of the present invention;

FIG. 7 is a cross sectional drawing schematically showing the structure of a color display unit of the present invention; and

FIG. 8 is a cross sectional drawing schematically showing the structure of a color display unit of the present invention.

### DETAILED DESCRIPTION OF THE PREFERRED EMBODIMENTS

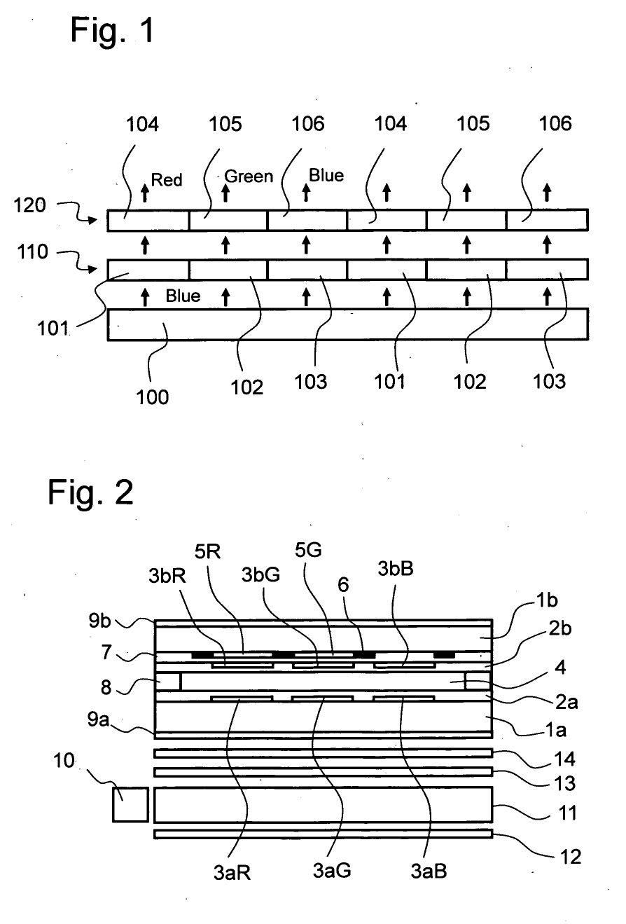

A color display unit of the present invention will be described using the drawings. FIG. 1 is a conceptual drawing showing the basic configuration of the color display unit of the present invention. As shown in FIG. 1, a switch structure 110 for performing transmission/non-transmission (ON/OFF) control for light transmission is provided closely above a light source 100 for emitting blue light. A color conversion layer 120 is also provided close to the switch structure 110.

This switch structure 110is comprised of pixel switches 101, 102 and 103 arranged in a matrix. The color conversion layer 120 is comprised of a first wavelength conversion region (red color region) 104 for converting blue light to light of a red wavelength region, a second wavelength conversion region (green color region) 105 for converting blue light to light of a green wavelength region, and a blue color region 106 for transmitting blue light, arranged in a matrix. Each pixel switch and each color region are laminated in correspondence with each other. With FIG. 1, pixel switches are provided between the color conversion layer 120 and the blue light source 100. Accordingly, the pixel switch 101 performs ON/OFF control for blue light incident on the red color region 104, the pixel switch 102 performs ON/OFF control for blue light incident on the green color region 105, and the pixel switch 103 performs ON/OFF control for blue light incident on the blue color region 106.

The switch structure 110 controls ON/OFF states of the pixel switches arranged in a matrix, in accordance with drive power from a drive circuit (not shown), to display a desired image. It becomes possible for blue light that has been ON/OFF controlled by these pixel switches to individually display red color information, green color information and blue color information within a pixel as a result of transmitting the red color region 104, green color region 105 and blue color region 106, and as a result it is possible to display a color image.

Although not shown in FIG. 1, an absorption layer for absorbing blue light wavelength region is provided at regions corresponding to the red color region 104 and the green color region 105. At this time, the color conversion layer 120 is arranged between this absorption layer and the blue light source. Using this type of structure, blue light that is transmitted without being wavelength converted by the red color region 104 or the green color region 105 is absorbed, and does not get through to an observer. As a result, color purity is improved.

It is possible to use a red fluorescent material layer containing red fluorescent material for wavelength converting blue light to red light as the red color region 104, and to use a green fluorescent material layer containing green fluorescent material for wavelength converting blue light to green light as the green color region 105. The blue color region 106 is formed so that there is minimal absorption and reflection of blue light, and the blue light is transmitted with good efficiency.

Also, if light from the observer side (external light) enters the red fluorescent material layer or the green fluorescent material layer, it is difficult to represent black because of light excited by this external light and light reflected at the surface of the fluorescent layer. For this reason, a circular polarizing element is arranged more to the observer side than the color conversion layer. With this type of structure, external light is circularly polarized and made incident on the color conversion layer, and it becomes impossible for light reflected at the surface of the color conversion layer to transmit the circular polarizing element. (This is because if the circularly polarized light is reflected it becomes reverse circularly polarized light.)

Also, together with providing the polarizing element for transmitting light of a particular polarization direction more to the observer side than the above described absorption layer, it is set so that a transmission axis of this polarizing element is almost orthogonal to the polarization direction of blue light transmitting the red color region (or the green color region). Further, together with providing a diffusion layer at regions corresponding to the blue color region, this diffusion layer is arranged between the polarizing element and the switch structure. With this type of structure, since blue light that cannot be absorbed by the absorption layer is prevented from reaching the observer by the polarizing element, color purity is improved. Also, blue light transmitting the blue color region is not polarized because of the diffusion layer, and so blue light transmitting the polarizing element exists at the blue light region.

Alternatively, although not shown in FIG. 1, a red color filter for selectively transmitting a red wavelength region is provided at a location corresponding to the red color region 104, and a green color filter for:selectively transmitting a green wavelength region is provided at a location corresponding to the green color region 105. The efficiency of the red color region and the green color region respectively wavelength converting blue light to red light and green light is not 100%, and light that has been wavelength converted has limitations, but since it has got a wide wavelength range color purity is lowered for red light and green light. For this reason, by causing the red light and the green light that has been wavelength converted to transmit the color filter (red or green) again, it becomes possible to increase color purity. Specifically, since it becomes possible to eliminate a blue light component that could not be wavelength converted by the color conversion layer, it is possible to improve color purity of the red light and the green light, and a result it is possible to widen the color reproduction range.

It is possible to use a well-known liquid crystal element, EC element, mechanical switch array element etc. as the switch structure 110. It is preferable to have a surface light source for emitting blue light in a uniform plane as the blue light source 100.

Also, an organic EL element or EL element capable of monochromatic blue color display functions as both the light source 10 and the switch structure 110.

In the following, an embodiment using a liquid crystal element as the switch structure will be described with reference to the drawings.

### Embodiment 1

The cross sectional structure of the display unit of this embodiment is shown schematically in FIG. 2. As shown in FIG. 2, the liquid crystal element is configured with a liquid crystal layer 4 enclosed in a gap between a glass substrate 1a and an opposing substrate 1b. Transparent electrodes 3aR, 3aG, 3aB, and an orientation film 2a on the transparent electrodes, are formed on the glass substrate 1a. On the other hand, a red fluorescent material layer 5R and a green fluorescent material layer 5G are formed on the opposing substrate. A black matrix 6 is formed in gaps between these fluorescent material layers, except for the blue color region. Formation regions for the red fluorescent material layer 5R, the green fluorescent material layer 5G and the black matrix 6 are flattened using a flattening layer 7. Transparent electrodes 3bR, 3bG and 3bB constituting pixel electrodes are formed on the flattening layer 7 opposite to the transparent electrodes 3aR, 3aG and 3aB. An orientation film 2b is also formed on these transparent electrodes 3bR, 3bG and 3bB. The glass substrate 1a and opposing substrate 1b of this type surface structure have film formation surfaces facing each other, and are joined at a specified gap by means of a spacer 8. Although not shown in the drawings, in order to form this gap it is common to disperse beads having a specified particle diameter inside the spacer 8.and between the substrates. A liquid crystal layer 4 is then enclosed in the gap between the substrates. Initial orientation of the liquid crystal element of the liquid crystal layer 4 is regulated by the orientation films 2a, 2b.

A lighting system is provided for lighting the liquid crystal element. With FIG. 2, a back light is used as the lighting system. With this embodiment, a blue LED 10 is used as a light source for the back light. The wavelength of light emitted by the blue LED is generally 450-475 nm. Blue light output from the blue LED 10 propagates to an inner part of a transparent light guide plate 11, and uniformly irradiated to the liquid crystal element side from a light-emitting surface, being a liquid crystal side surface. Here, a reflecting plate 12 for improving light irradiation efficiency is provided at a rear surface side of the light guide plate. It is possible to omit the reflecting plate, depending on the shape of positions of prisms formed on the surface of the light guide plate 11. A light diffusion sheet 13 is also provided between the light guide plate and the liquid crystal element. The light diffusion sheet 13 has microscopic irregular shapes formed on the surface, and is coated with beads to provide a function of diffusing light. A prism sheet 14 for regulating light emission direction is also provided between the light diffusion sheet 13 and the liquid crystal element. A plurality of microscopic prisms are formed in an aligned manner on a rear surface of the prism, sheet 14, and the sheer 14 operates to regulate the light emission direction using these prisms. The microscopic prisms have a substantially right angled triangle cross section, with a ridge line parallel to the light incidence light plane of the light guide plate 11. It is also possible to use two prism sheets with ridge lines of the microscopic prisms orthogonal to each other as the prism sheet 14. The above-described backlight only uses a blue LED as a light source, thus constituting a light source irradiating uniform blue light to the liquid crystal element.

Blue light that has been irradiated from the backlight of this type of structure towards the liquid crystal element has only a particular diffusion component transmitted at the diffusion plate 9a. At this time, in a state where a drive voltage is not applied between the transparent electrodes 3aR, 3aG and 3aB and the transparent electrodes 3bR, 3bG and 3bB, a case where a * diffusion plate is disposed to that light that has transmitted a pixel transmits the diffusion plate 9b is called normally white, and a case where the diffusion plate is disposed so that the light that has transmitted a pixel does not transmit the diffusion plate 9b is called normally black. In the case of normally white, when a specified drive voltage is applied between the transparent electrodes 3aR, 3aG and 3aB and the transparent electrodes 3bR, 3bG and 3bB, light stops transmitting at the diffusion plate 9b, while in the case of normally black the diffusion plate. 9b transmits light. Specifically, the liquid crystal element shown in FIG. 2 operates as switch means for turning blue light ON or OFF by regulating the drive voltage. A case where the liquid crystal element is formed normally white will be described in the following.

In FIG. 2, when the drive voltage is applied to the transparent electrode 3aR and the transparent electrode 3bR, blue light from the back light transmits the diffusion plate 9a, glass substrate 1a, the transparent electrodes and the liquid crystal layer. 4 and is wavelength converted by the red fluorescent material layer 5R to become red light, and the red light is observed after transmitting the glass substrate 1b and the diffusion layer 9b. That is, the color observed in the pixel region at this time is red. Similarly, blue light reaching the green fluorescent material layer 5G is wavelength converted and observed as green light. Also, blue light that transmits the transparent electrode 3aB and the transparent electrode 3bG transmits the diffusion plate 1b, and is observed as is as blue light. A red color region formed from the red fluorescent material layer 5R, a green color region formed from the green fluorescent material layer 5R, and a blue color region transmitting the blue light as is are grouped together to make a pixel, and the chromaticity displayed by the pixel is determined by modulating a voltage applied to the liquid crystal layer 4 corresponding to these regions. At this time, brightness is high because it is possible to obtain red, green and blue using the luminescence of the fluorescent material, and as a result wider color representation becomes possible.

The red fluorescent material layer 5R and the green fluorescent material layer 5G comprise a substrate, activation body and solvent. The substrate is selected from inorganic fluorescent material such as oxides of cadmium, magnesium, silicon or rare earth elements such as yttrium, sulfides, silicates or vanadic acid, or organic fluorescent material such as fluorescent resin or types of oil (mineral oil) The activation body is selected from silver, copper, manganese, europium, zinc, aluminum, lead, phosphor, arsenic or gold. The solvent is selected from sodium chloride, potassium chloride, magnesium carbonate or barium chloride. For example., as the material for forming the red fluorescent material layer 5R, it is possible to use SrS with Eu added as a rare earth element, CaS or CaAlSiN₃, and as the green fluorescent material layer 5G, for example, it is possible to use SrGa₂S2₄ with Eu added as a rare earth element or Ca₃Sc₂Si₃O₁₂ with Ce added. Incidentally, as shown in FIG. 2, the black matrix 6 is formed in gaps between respective pixel regions so that irradiated light does not leak from the gap and lower color purity.

### Embodiment 2

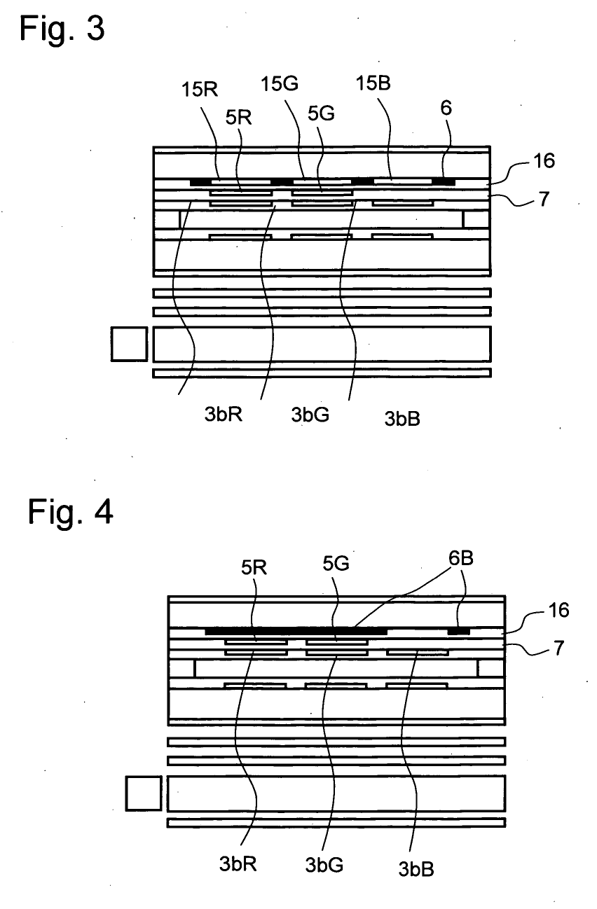

The cross sectional structure of the display unit of this embodiment is shown schematically in FIG. 3. This embodiment is different from embodiment 1 in that a red color filter 15R is formed corresponding to the red color region, a green color filter 15G is formed corresponding to the green color region, and a blue color filter 15B is formed corresponding to the blue color region. These color filters are formed corresponding to each color region, with a macromolecular base material containing colorant or pigment so as to selectively transmit only the respective red wavelength range, green wavelength range or blue wavelength range. As shown in the drawing, with this embodiment the color filters 15R, 15G and 15B are flattened with a second flattening layer 16, and the red fluorescent material layer 5R and the green fluorescent material layer 5G are formed on this flattening layer. The black matrix 6 is also formed in a gap between each of the color filters.

The efficiency of the red fluorescent material layer 5R and the green fluorescent material layer respectively wavelength converting blue light to red light and green light is not 100%, and light that has been wavelength converted has limitations, but since it has got a wide wavelength range color purity is lowered for red light and green light. Accordingly, by passing light that has been wavelength converted by these fluorescent material layers 5R and 5G through the color filters 15R and 15G again, it is possible to increase color purity, and as a result it is possible to widen a color reproduction range for display elements of the present invention. Incidentally, since the color purity of the light from the blue LED is extremely high, the blue color filter 15B can be omitted.

With the two embodiments described above, each of the fluorescent material layers is arranged directly above the observer side transparent electrodes 3bR, 3bG and 3bB, but it goes without saying that they can also be arranged directly below the rear surface side transparent electrodes 3aR, 3aG and 3aB. A case where a simple matrix type liquid crystal element is used as the liquid crystal element has been shown, but it goes without saying that it is also possible to use other liquid crystal elements such as a TFT liquid crystal element. Also, although not shown in each of the embodiments, it is possible to make flattening of the fluorescent material layers with the leveling layer 7 better by forming a transparent dummy layer having almost the same film thickness as the red fluorescent material layer 5R and the green fluorescent material layer 5G on the blue color region.

### Embodiment 3

The cross sectional structure of the display unit of this embodiment is shown schematically in FIG. 4. This embodiment us different from embodiment 2 in that color filters for each color are not provided, and a blue mask 6B for cutting the blue wavelength (450-480 nm) is provided. The blue mask 6B is open only at blue color regions, and elsewhere exists on the red color region and the green color region. Therefore, a wavelength component in the blue color region contained in light that has transmitted the red color region and the green color region is cut by this blue mask 6B. That is, equivalent operation to that the red color filter 15R and the green color filter 15G of embodiment 2 is obtained. According to this type of structure, it is possible to do away with the color filter layers, and it is possible simplify the manufacturing process.

The blue mask 5B has a peak wavelength of from 450 nm to 480 nm, and has transmission characteristics such that so-called blue visible light is cut. For example, the mask can be formed by diffusing a yellow material of isoindolinone series in a transparent resin and patterning. It is possible to use a screen printing method or a, photolithography method as a patterning method.

### Embodiment 4

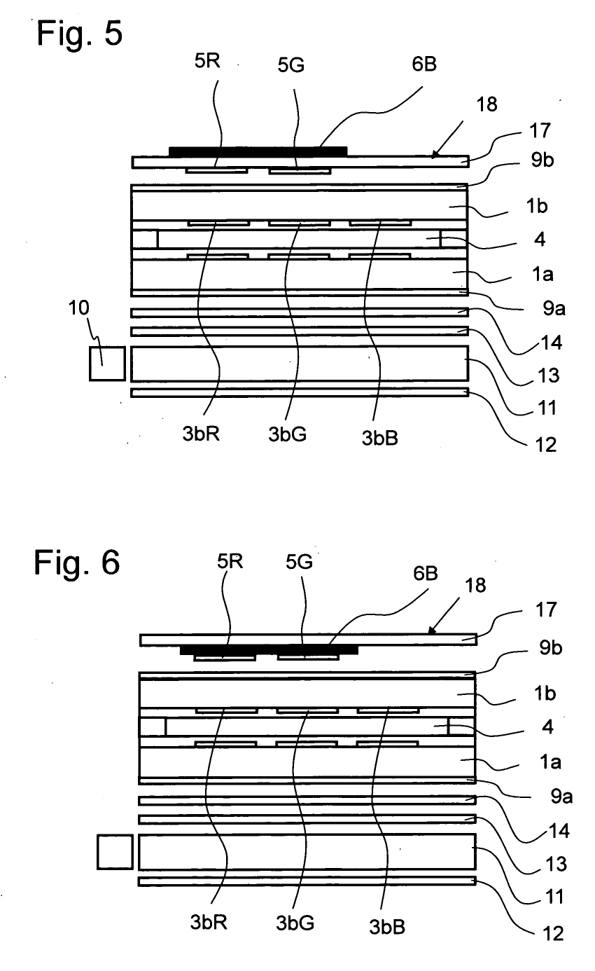

The cross sectional structure of the display unit of this embodiment is shown schematically in FIG. 5. With this embodiment, a transparent substrate with a fluorescent material layer 18 is arranged above a liquid crystal display element. As shown in the drawing, the transparent substrate with the fluorescent material layer 18 has the red fluorescent material layer 5R and the green fluorescent material layer 5G selectively coated on the transparent substrate 17, and also has a blue mask 6B coated on the opposite side surface. The transparent substrate 17 is preferably a transparent plate such as clear resin or glass. Also, the red fluorescent material layer 5R, the green fluorescent material layer 5G and the blue mask 6B must be patterned into a dot pattern etc. but it is possible to use a screen printing method or a photolithography method. Also, as long as thickness of the red fluorescent material layer and the green fluorescent material layer 5G are such that all of the blue light can be color converted, the blue mask 6B is not strictly necessary, and can be omitted.

FIG. 6 shows the structure in the case where the arrangement of the blue mask 6B on the transparent substrate having a fluorescent material layer 18 is on the same side as the fluorescent material layer. Specifically, the blue mask 6B is patterned on the transparent substrate 17, and the red fluorescent material layer 5R and the green fluorescent material layer 5G are patterned on the blue mask 6B, and the fluorescent material layer us arranged so as to face the liquid crystal display unit. With this type of structure, it is possible to use the transparent substrate 7 as a cover, and it becomes possible to protect the liquid crystal display unit against external impact etc. Further, it is possible to provide a display unit that is not affected by external light, by forming an antireflection film such as AR on the fluorescent material layer and on the opposite surface of the transparent substrate 17.

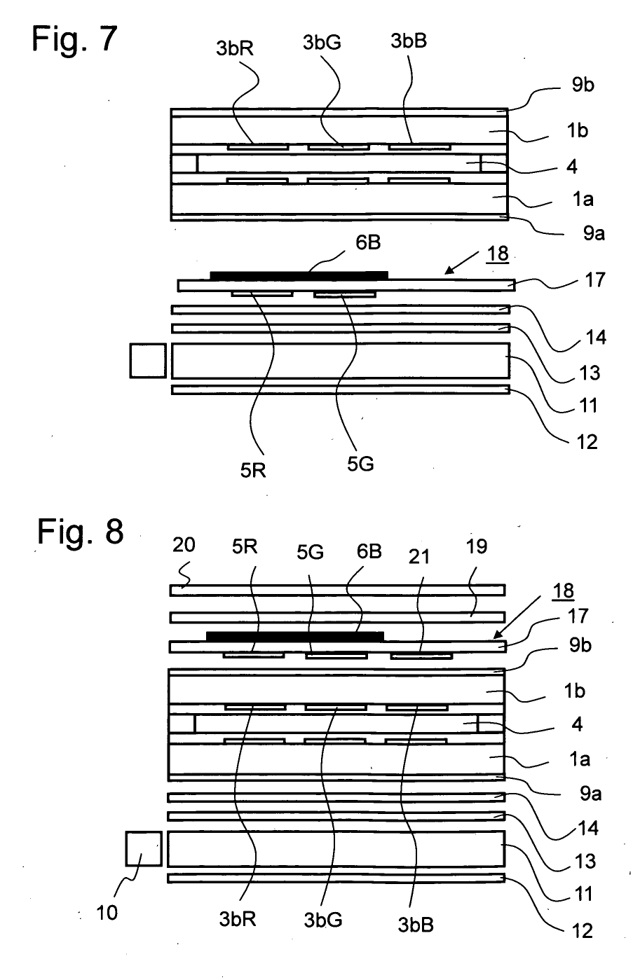

FIG. 7 shows the structure where the transparent substrate with a fluorescent layer is arranged between the liquid crystal display element and a back light. Blue light has a short wavelength compared to other visible light, and so attenuation is large. As a result, the fluorescent layers become more advantageous if they are arranged close to the light source, and this structure is ideal from the point of view of efficiency of light utilization. The position of the blue mask 6B on the transparent substrate with a fluorescent layer can also be the opposite surface to the fluorescent layer or below the fluorescent layer, or there can be no blue mask 6B.

### Embodiment 5

The cross sectional structure of the display unit of this embodiment is shown schematically in FIG. 8. As shown in the drawing, this embodiment is configured with a transparent substrate with a fluorescent layer 18 arranged on the liquid crystal display element unit, a polarizing element 19 arranged on the transparent substrate with a fluorescent layer 18, and a diffusion layer 21 for blue arranged on a blue color transmitting area.

Light emitted by the blue LED 10 passes through the liquid crystal display element, and constitutes blue light of a linearly polarized component. If this blue light is made incident on the red fluorescent material layer 5R, for example, part of that light is colored as red light, and the remaining light is transmitted as is as blue polarized light. The transmitted polarized blue light is absorbed by the blue mask 6B, but complete absorption is not possible and a microscopic amount transmits. For this reason, there is an effect of lowering color purity of red light.

The polarizing element for transmitting light of a particular polarization direction is arranged at the observer side, and is set so that a transmission axis of this polarizing element 19 and the polarization direction of blue light blue polarized light are substantially orthogonal. In this way, it is possible to prevent the blue polarized light transmitting. Light emitted from the red fluorescent material layer 5R is light that has not been polarized, and so is transmitted even if the polarizing element 19 exists. The same phenomenon arises with the green fluorescent layer 5G. Also, a diffusion layer 21 for blue is arranged on the blue color transmitting area. Blue polarized light is not polarized as a result of transmitting the diffusion layer for blue, and becomes non-polarized light. Therefore, this light is transmitted despite the fact that the polarizing layer 19 exists.

Further, if external light enters the red fluorescent material layer 5R and the green fluorescent material layer 5G, light that is not cut by the blue mask 6B constitutes excitation light and light will be generated, a state where there is always illumination arises due to reflection at the surface of the fluorescent layer, and it is difficult to achieve black. Therefore, by arranging a circularly polarizing element 20 outside the transparent substrate with a fluorescent layer 18, external light is polarized to circularly polarized light, a light resulting from reflection at the surface of the fluorescent layer is cut by the circularly polarizing element 20. Specifically, the structure has an external light cutting function outside the transparent substrate with a fluorescent layer 18. Since input of external light is reduced by half by the polarizing element 19 and the circularly polarizing element 10, there is the effect of also reducing a component for excitation and emission due to the external light.

As has been described above, the color display unit of the present invention converts blue light to red light and green light using fluorescent material, and a color image is obtained using the converted red light and green light, and the blue light that was used as excitation light, and therefore there is the effect that it is possible to display c color image with a wide range of color reproduction.

Also, by using a liquid crystal element as a switch structure for turning the blue light ON or OFF, it is possible to achieve a low power consumption color display unit provided with a dual function of brightness as passive elements and of maintaining viewability of an image as emitting elements.

The color display unit of the present invention can display a color image without lowering strength of blue light that is extremely easy to absorb, and so it is possible to realize a brighter color image.

What is claimed is:

1. A color display unit comprising:
a blue light source for emitting blue light;
a color conversion layer, having a first wavelength conversion region for converting the blue light to light of a red wavelength region, a second wavelength conversion region for converting the blue light to light of a green wavelength region, and a blue color region for transmitting blue light, arranged on a flat surface; and
a switch structure, formed respectively corresponding to the first wavelength conversion region, the second wavelength conversion region, and the blue color region, for controlling transmission and non-transmission of light from the blue light source.

2. The color display unit according to claim 1, wherein the switch structure is provided between the color conversion layer and the blue light source.

3. The color display unit according to claim 1, further comprising an absorption layer for absorbing a wavelength region for blue light, wherein the absorption layer is provided at locations corresponding to the first wavelength conversion region and the second wavelength conversion region, and the color conversion layer is provided between the absorption layer and the blue light source.

4. The color display unit according to claim 3, wherein the color conversion layer and the absorption layer are formed on a transparent substrate.

5. The color display unit according to claim 3, further comprising a polarizing element for transmitting light of a particular polarization direction, the polarizing element is provided more to an observer side that the absorption layer, and a transmission axis of the polarizing element is set so as to be orthogonal to a polarization direction of polarized light transmitting the first wavelength conversion region or the second wavelength conversion region.

6. The color display unit according to claim 5, further comprising a diffusion layer provided at location corresponding to the blue color region, wherein the diffusion layer is arranged between the polarizing element and the switch structure.

7. The color display unit according to claim 1, further comprising a circularly polarizing element provided more to the observer side than the color conversion layer.

8. The color display unit according to claim 1, further comprising a red color filter for selectively transmitting a red wavelength range provided at locations corresponding to the first wavelength conversion region, and a green color filter for selectively transmitting a green wavelength range provided at locations corresponding to the second wavelength conversion region.

9. The color display unit according to claim 8, further comprising a blue color filter for selectively transmitting a blue color range provided so as to correspond to the blue color region.

10. The color display unit according to claim 8, further comprising a blue mask for absorbing light provided in gaps between the red color filter and the green color filter, and at locations not corresponding to the blue color region.

11. The color display unit according to claim 1, wherein the first wavelength conversion region is formed from a red fluorescent material layer that emits red light upon excitation by blue light, and the second wavelength conversion region is formed from a green fluorescent material layer that emits green light upon excitation by blue light.

12. The color display unit according to claim 1, further comprising a flattened film provided so as to cover the first wavelength conversion region, the second wavelength conversion region and the blue color region.

13. The color display unit according to claim 1, wherein the switch structure is a liquid crystal display element.

14. The color display unit according to claim 1, wherein a self-emissive type display element is used instead of the blue light source and the switch structure.
